(19) United States
(12) Patent Application Publication
(10) Pub. No.: US 2017/0200941 A1
(43) Pub. Date: Jul. 13, 2017

(54) NANO-CARBON COMPOSITE AND METHOD FOR PRODUCING THE SAME

(71) Applicant: NEC Corporation, Tokyo (JP)

(72) Inventor: Ryota YUGE, Tokyo (JP)

(73) Assignee: NEC Corporation, Tokyo (JP)

(21) Appl. No.: 15/315,491

(22) PCT Filed: Jun. 3, 2015
(86) PCT No.: PCT/JP2015/066044

§ 371 Date: Dec. 1, 2016

(30) Foreign Application Priority Data
Jun. 6, 2014 (JP) 2014-117431

(51) Int. Cl. H01M 4/36; C04B 35/626; C04B 41/50; H01M 4/62; H01M 4/133; H01M 4/587; H01M 10/0525; H01M 4/48; C04B 35/80; C04B 41/00

(52) U.S. Cl. CPC H01M 4/364; C04B 35/806; C04B 35/6268; C04B 41/5001; C04B 41/009; H01M 4/133; H01M 4/587; H01M 10/0525; H01M 4/366; H01M 4/483; H01M 4/625; C04B 2235/3418; C04B 2235/422; C04B 2235/5248; C04B 2235/52; C04B 2235/656; C04B 2235/96

(57) ABSTRACT

In order to provide a negative electrode material for a lithium-ion secondary battery that achieves both of high capacity and rapid charge/discharge performance, a nano-carbon composite is used as the negative electrode material. The nano-carbon composite 7 includes: low-crystallinity carbon 1; a composite in which a mixture of silicon oxide 2 containing silicon nanoparticles 3 and fibrous carbon 4 are partially or entirely coated with a carbon coating 5; and carbon nanohorn aggregates 6 supported on a surface of the composite.

### TECHNICAL FIELD

The present invention relates to a nano-carbon composite having a high charge/discharge capacity and an excellent cycle characteristics and provides a high rate performance when the composite is used as an active material of a negative electrode material for a lithium-ion secondary battery, and a method for producing the nano-carbon composite.

### BACKGROUND ART

Today, with the size reduction, weight reduction, and improvement of performance of mobile phones, notebook personal computers and electric vehicles, lithium-ion batteries, which are light weight and have large charge capacities, are becoming widely used as secondary batteries for these apparatuses. Applications such as mobile phones, electric vehicles and stationary battery require lithium-ion batteries that have high capacities and can be fast discharged and charged.

For increasing capacities, Si-based negative electrodes, which have large capacities per unit weight, are more promising than conventional graphite-based negative electrodes. In addition, because Si materials are a plentiful resource, Si-based negative electrodes are advantageous in terms of future cost. However, when these materials are used as active materials for negative electrodes, rapid charge and discharge cannot be achieved because of their low conductivity. In addition, there is a problem that a large volume change occurs after repeated charge/discharge cycles.

For rapid charge/discharge, with respect to active materials in negative electrodes, a switch from graphite-based materials to low-crystallinity carbon materials, such as graphitizable carbon and non-graphitizable carbon, which have good rate performance, has been proposed. However, a problem with these low-crystallinity carbon materials is that the use of the low-crystallinity carbon materials significantly reduces the capacity as compared with graphite-based materials.

Further, attempts have been made to reduce the resistance in electrodes and conduction aids are under primary consideration. Examples of conduction aids include acetylene black, ketjen black, furnace black, carbon fibers, and carbon nanotubes. Among these conduction aids, carbon-black-based conduction aids exemplified by acetylene black can be relatively easily dispersed because they have a spherical shape and a tendency to cling to the surfaces of electrode active materials. Materials such as carbon nanotubes are known to have a greater conductivity adding effect than carbon black-based materials because carbon nanotubes have a graphene sheet structure formed along the fiber axis and a conducting path of several micrometers can be made. However, carbon nanotubes cannot easily be dispersed; if the dispersibility of carbon nanotubes can be increased, their resistance can be further reduced.

PTL 1 (Japanese Laid-open Patent Publication No. 2002-42806) discloses a technique that coats the surfaces of silicon oxide, which is a Si-based material, with an electronically conductive material such as carbon using a chemical vapor deposition method, liquid-phase deposition method, calcination method, ball milling method, or mechanical alloying method to provide electronical conductivity between particles, thereby increasing the energy density of a battery.

PTL 2 (Japanese Laid-open Patent Publication No. 2010-118330) uses a Si-based material, which has a large discharge capacity, as a negative-electrode active material and hybridizes carbon nanohorns as a conducting agent to allow for a sufficient volume occupation of the negative-electrode active material, thereby achieving a large capacity and a good charge/discharge cycle characteristics.

PTL 3 (Japanese Laid-open Patent Publication No. 2010-123437) discloses a long-life lithium-ion battery in which carbon nanohorn aggregates which have high dispersibility and high conductivity are mixed into a graphite material of the negative electrode to achieve a small reaction resistance and a small volume expansion coefficient and prevent a rapid degradation in capacity.

PTL 4 (Japanese Laid-open Patent Publication No. 2011-18575) discloses a material produced by mixing carbon fibers and carbon black into silicon/carbon composite powder.

### CITATION LIST

### Patent Literature

[PTL 1] Japanese Laid-open Patent Publication No. 2002-42806
[PTL 2] Japanese Laid-open Patent Publication No. 2010-118330
[PTL 3] Japanese Laid-open Patent Publication No. 2010-123437
[PTL 4] Japanese Laid-open Patent Publication No. 2011-18575

### SUMMARY OF INVENTION

### Technical Problem

The approaches described above do not sufficiently achieve both of high capacity and rapid charge/discharge performance and it is also difficult for the approaches to mitigate volume changes caused by charging and discharging. Therefore, an object of the present invention is to provide a negative electrode material for a lithium-ion secondary battery that achieves both of high capacity and rapid charge/discharge performance.

### Solution to Problem

The present invention includes the following aspects for solving the problem described above.

One aspect of the present invention relates to a nano-carbon composite including: low-crystallinity carbon; a composite in which a mixture of silicon oxide containing silicon nanoparticles and fibrous carbon are partially or entirely coated with a carbon coating; and carbon nanohorn aggregates supported on a surface of the composite.

One aspect of the present invention is characterized in that the low-crystallinity carbon is selected from graphitizable carbons.

One aspect of the present invention is characterized in that the composite contains 50% or less of the silicon oxide by mass, 0.1 to 10% of the fibrous carbon by mass, 0.1 to 10% of the carbon coating by mass, and the remainder being the low-crystallinity carbon, and the carbon nanohorn aggregates are 1 to 30% by mass to the composite.

One aspect of the present invention is characterized in that the low-crystallinity carbon is particles having an average particle size in the range between 100 nm and 100 μm inclusive, silicon nanoparticles contained in the silicon oxide have a diameter less than or equal to 20 nm, and the silicon oxide is particles having an average particle size in the range between 100 nm and 50 μm inclusive.

One aspect of the present invention is characterized in that the carbon nanohorn aggregates are of one type selected from the group consisting of petal type, dahlia type, bud type, and seed type or a mixture of two or more types selected from the group.

One aspect of the present invention is characterized in that the fibrous carbon is of at least one type selected from the group consisting of carbon nanofiber and carbon nanotube.

Another aspect of the present invention is an electrode material for a lithium-ion secondary battery that includes the nano-carbon composite described above and at least one conduction aid selected from the group consisting of carbon black, acetylene black, ketjen black, furnace black, activated carbon, carbon nanotube, carbon nanofiber, and graphene.

Another aspect of the present invention is a lithium-ion secondary battery including the nano-carbon composite described above or the electrode material described above.

Another aspect of the present invention relates to a method for producing a nano-carbon composite, including the steps of:

forming a mixture of low-crystallinity carbon or a precursor of low-crystal carbon, silicon oxide (SiOx (0<x<2)), and fibrous carbon; changing the silicon oxide to silicon oxide containing silicon nanoparticles by heating the mixture at a temperature in the range between 500° C. and 1800° C. inclusive in a non-oxidizing atmosphere;

forming a composite by partially or entirely coating a surface of the mixture with a carbon coating; and

supporting carbon nanohorn aggregates on a surface of the composite.

Another aspect of the present invention is characterized in that, in the producing method described above, the carbon coating is formed by depositing an organic substance on a surface of the mixture and carbonizing using heat burning of the organic substance at a temperature of 500° C. to 1800° C. or by using a carbon source to perform chemical vapor deposition at a temperature of 400° C. to 1200° C.

### Advantageous Effects of Invention

According to the present invention, because low-crystallinity carbon, silicon oxide, and fibrous carbon are coated with a carbon coating and combined into a composite, conducting paths are provided between them, so that a low resistance is achieved. In addition, because highly dispersible and highly conductive carbon nanohorn aggregates are supported on the surface of the composite, the internal resistance of the electrode is reduced. Moreover, the silicon nanoparticles in silicon oxide enables a further increase of the capacity. A volume change of silicon due to charge/discharge is mitigated because of the inclusion of silicon in silicon oxide and the presence of the carbon coating and the carbon nanohorn aggregates.

### BRIEF DESCRIPTION OF DRAWINGS

FIG. 1 is a diagram generally illustrating a structure according to the present invention.

FIG. 2 is a diagram illustrating a thermogravimetric analysis of composite C produced in accordance with the present invention.

FIG. 3 is an electron scanning microscopy image of composite B produced according to the present invention.

### DESCRIPTION OF EMBODIMENTS

Example embodiments of the present invention which have the features described above will be described below.

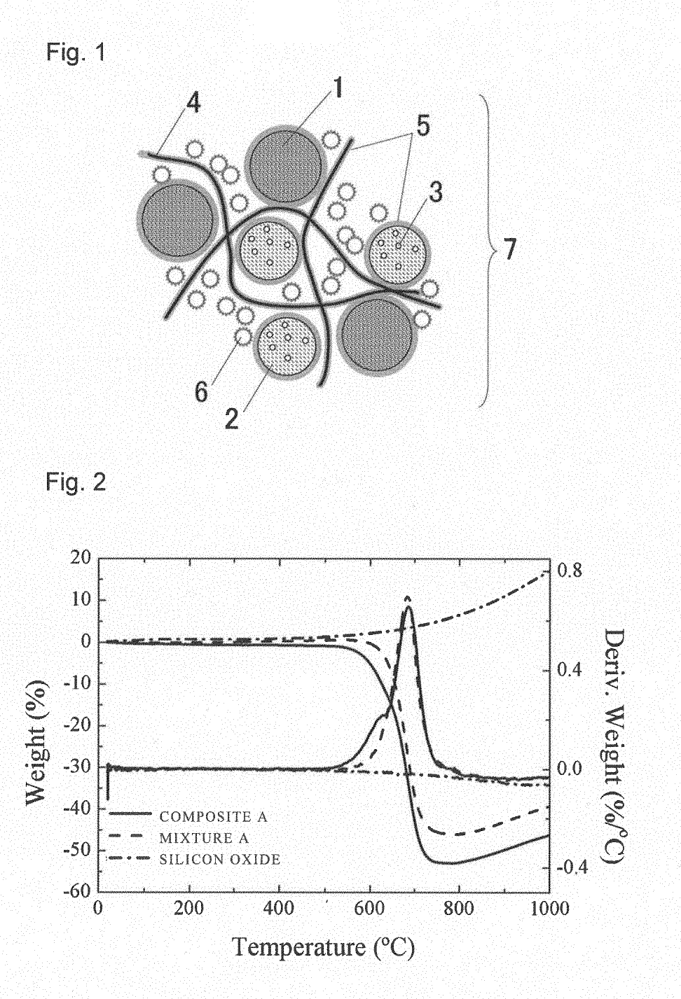

FIG. 1 is a diagram generally illustrating a nano-carbon composite 7 according to the present invention.

To produce the nano-carbon composite 7 according to the present invention, low-crystallinity carbon 1, fibrous carbon 4 and silicon oxide 2 are mixed. The resulting mixture is heat-treated to precipitate silicon nanoparticles 3 inside the silicon oxide. Then the surface of the mixture is coated with a carbon coating 5 to form a composite. Lastly, carbon nanohorn aggregates 6 are supported on the surface of the composite. A “composite” as simply referred to herein is the composite before supporting carbon nanohorn aggregates 6 and is used as distinguished from the nano-carbon composite 7 on which the carbon nanohorn aggregates 6 are supported.

Low-crystallinity carbon includes graphitizable carbon and non-graphitizable carbon. Low-crystallinity carbon may be produced by the above-described heat-treating using a precursor compound of low-crystallinity carbon. Examples of precursors of graphitizable carbon include oil-based materials such as petroleum pitch, coal pitch and low-molecular-weight heavy oil as well as mesophase pitch which can be obtained by heat-treating any of these materials at about 400° C. Examples of precursors of non-graphitizable carbon include polyimide resin, furan resin, phenol resin, polyvinyl alcohol resin, cellulose resin, epoxy resin, polystyrene resin, and saccharides such as sucrose. Graphitizable carbon (for example, pitch coke) and non-graphitizable carbon which are directly used can be obtained by separately heat-treating these precursors. Heat-treating a precursor allows low-crystallinity carbon to take fibrous carbon into itself, which further improves the conductivity between low-crystallinity carbon particles. Low-crystallinity carbon is preferably selected from graphitizable carbons.

Silicon oxide, written as SiOx, that satisfies 0<x<2 can be used. SiOx having a composition that is nonstoichiometric with respect to quadrivalent silicon (Si (IV)) is called Si suboxide and is known to be decomposed into a Si phase and a SiO₂ phase at high temperature. The Si phase crystallizes and nano-sized silicon particles (Si nanoparticles) precipitate and become present inside silicon oxide. Because only a small amount of oxygen enters and leaves, the composition of the silicon oxide particles as a whole only slightly changes. Such Si suboxide that satisfies 0.5≦x≦1.5 is more preferable and Si suboxide with x that is greater than or equal to 0.5 can minimize a decrease in cycle characteristics because the amount of formed Si particles which significantly changes in volume is not excessively large. On the other hand, if x is smaller than or equal to 1.5, the amount of Si particles formed will be such that the charge/discharge capacity is within a practical range. The particle diameter of silicon oxide that can be used is in the range of 500 nm to 100 μm, and is preferably in the range of 1 μm to 40 μm. Si nano particles have a diameter less than or equal to 20 nm, and more preferably have a diameter of several nanometers. Material Si suboxide particles can be obtained by using a well-known method and may be obtained by reduction treatment of silica particles, for example. Alternatively, commercially available particles such as silicon monoxide (SiO) may be used. Pure silicon monoxide has a composition that is stoichiometric with respect to divalent silicon (Si (II)) and is usually gas. Silicon monoxide solidified in vitreous form is disproportionated and commercially available silicon monoxide is a composite of Si atoms and SiO₂.

Preferably, fibrous carbon has a diameter smaller than the particle size of the low-crystallinity carbon. Although the length of the fibrous carbon is not particularly specified, the length of the fibrous carbon is preferably greater than the particle size of the low-crystallinity carbon. If a low-crystallinity carbon precursor is used, fibrous carbon has preferably a length that can connect a plurality of particles of low-crystallinity carbon together while the fibrous carbon is taken into a plurality of low-crystallinity carbon particles. Typically, nano-carbon fibers or carbon nanotubes having a diameter of less than or equal to 1 μm and a length of 1 to 5000 μm can be used. A diameter of less than or equal to 100 nm and a length of less than or equal to 100 μm are especially preferable.

Heat treatment for conversion of a low-crystallinity carbon precursor to low-crystallinity carbon or precipitating Si nanoparticles inside silicon oxide may be performed at a temperature in the range between 500° C. and 1800° C. inclusive. In the heat treatment, graphitization of the low-crystallinity carbon may partially progress and the capacity may be improved. A temperature in the range between 800° C. and 1200° C. is more preferable. A temperature higher than or equal to 800° C. enables conversion of a precursor to low-crystallinity carbon, progress of graphitization of the low-crystallinity carbon and crystallization of Si in silicon oxide to be accomplished at the same time. A temperature lower than or equal to 1200° C. can slow down particle growth of Si, prevent overgrowth of particles, and prevent an increase of volume changes due to charging and discharging. The heat treatment can be performed in a non-oxidizing atmosphere, for example in a vacuum, in a non-oxidizing gas atmosphere (for example, nitrogen gas, hydrogen gas, inert gas (rare gas) or the like). The heat treatment may be performed in a non-oxidizing gas atmosphere of a combination of a plurality of gasses. Note that the heat treatment is not essential to the production of a mixture; for example, a mixture may be produced by mixing silicon oxide containing Si nanoparticles that have been heat-treated in advance, low-crystallinity carbon, and fibrous carbon.

A carbon coating on the mixture may be formed using a chemical vapor deposition (CVD) method, sputtering method, arc vapor deposition method, liquid phase (hydrothermal synthesis) method, calcination method, ball milling method, or mechanical alloying method. The chemical deposition, CVD method, is especially preferable because the deposition temperature and deposition atmosphere can be easily controlled. The CVD method can be used in such a way that a nano-carbon mixture is placed in a boat or the like made of alumina or quartz, or is suspended or carried in gas. Alternatively, a carbon coating can be formed by depositing an organic substance on a surface of the mixture and carbonizing using heat burning of the organic substance at a temperature of 500° C. to 1800° C. The organic substance is preferably a water-soluble organic substance, a mixture may be dispersed in an aqueous solution of the organic substance, hydrothermal synthesis may be performed or the mixture may be taken out of the aqueous solution and then burnt. Saccharides such as sucrose is preferably used as the organic substance.

In the CVD method, any carbon source can be used that generates carbon by decomposition of the carbon source by heat. The carbon source may be a hydrocarbon compound such as methane, ethane, ethylene, acetylene, or benzene, an organic solvent such as methanol, ethanol, toluene, or xylene, and CO. In formation of a carbon coating, inert gas such as argon or nitrogen, or mixed gas of any of these and hydrogen may be used as the carrier gas and may be heated to a heating temperature in the range of 400 to 1200° C.

The flow rate of a carbon source compound and a carrier gas in the CVD reaction may be in the range of 1 mL/min to 10 L/min as appropriate.

The flow rate of the compound that serves as the carbon source is more preferably in the range of 10 mL/min to 500 mL/min, so that a more uniform coating can be made. The flow rate of the carrier gas is more preferably in the range of 100 mL/min to 1000 mL/min. Pressure may be in the range of 1.3 kPa to 1.3 MPa (10 to 10000 Torr) and is more preferably in the range of 53.3 kPa to 113.3 kPa (400 to 850 Torr).

The thickness of the carbon coating may be in the range between 1 nm and 100 nm inclusive and is more preferably in the range of 5 nm to 30 nm. A thickness of the carbon coating in the ranges given above can provide a sufficient conductivity and ensure a sufficient capacity.

The percentage of silicon oxide containing silicon nanoparticles that is present in the composite is preferably 50% or less by mass. The percentage by mass of fibrous carbon is preferably in the range of 0.1 to 10% by mass and the percentage of a carbon coating is preferably in the range of 0.1 to 10% by mass and the remainder is preferably the low-crystallinity carbon.

Each carbon nanohorn in a carbon nanohorn aggregate has a conical shape in which an end of a rolled graphene sheet is closed and is pointed like a horn with a point angle of about 20° , for example. The shape of each carbon nanohorn has a diameter in the range of about 1 nm to about 5 nm and a length in the range of about 10 nm to about 250 nm. Carbon nanohorns can be produced using a laser ablation method in which a carbonaceous material (such as graphite) is irradiated with a carbon dioxide gas laser or an arc discharge method, for example. Typically, carbon nanohorns can be radially aggregated for example in such a manner that one end of each conical shape points outward to form a carbon nanohorn aggregate having a spherical shape with a diameter of about 100 nm, for example. The carbon nanohorn aggregate includes an aggregate having any shape with a diameter in the range of 30 to 500 nm, preferably in the range of 30 to 200 nm. Further, carbon nanohorns or carbon nanohorn aggregates also include those of a dahlia type which has long horn structures, a bud type which has short horn structures, a seed type, and a petal-structure type which has plate-like horns (with a layered graphene sheet structure). Carbon nanohorns and their aggregates are detailed, for example, in Japanese Laid-open Patent Publication No. 2012-41250 by the present inventor. The internal spaces of carbon nanohorn aggregates can be made available by producing small openings in each nanohorn, thereby significantly increasing the specific surface area to increase the capacity. When small openings are formed in the carbon nanohorns, the size of the openings can be controlled under various oxidization conditions. In oxidization by heat treatment in an oxygen atmosphere, the size of openings in the nanohorns can be controlled by changing oxidization temperature; openings having a diameter in the range of 0.3 to 1 nm can be formed at a temperature in the range of 350 to 550° C. Alternatively, a process using acid or the like may be used to form openings as described in Japanese Laid-open Patent Publication No. 2003-95624. In the case of a nitric acid solution, a 1-nm opening can be formed at 110° C. in a period of 15 minutes; in the case of hydrogen peroxide, a 1-nm opening can be formed at 100° C. in two hours. When a mixture is produced using a low-crystallinity carbon precursor, carbon nanohorn aggregates may be mixed with silicon oxide and fibrous carbon to cause the carbon nanohorn aggregates to be taken into the low-crystallinity carbon.

Carbon nanohorn aggregates can be supported using a liquid phase or solid phase process. While carbon nanohorn aggregates may be mixed with composites in any proportion, a percentage by mass in the range of 1 to 30% to the composites is possible and a percentage by mass in the range of 1 to 10% is preferable. An additional carbon material may be mixed as a conduction aid, which may be carbon black, acetylene black, ketjen black, furnace black, activated carbon, carbon nanotubes, carbon nanofibers, graphene or the like. Note that these conduction aids may be mixed as a material of the electrode separately from supporting the carbon nanohorn aggregates or may be added in a slurry preparation stage, which will be described later. These conduction aids may be used singly or in combination.

A lithium-ion battery according to example embodiments of the present invention include a negative electrode containing the nano-carbon composite material, a positive electrode and an electrolyte. The lithium-ion battery according to the present invention can be primarily used as a secondary battery.

### (Negative Electrode)

The nano-carbon composite of the present example embodiment described above can be used as a material of an electrode of a lithium-ion battery, in particular as a material of a negative electrode and the negative electrode material is used as a negative-electrode active material. This enables in particular a high capacity and rapid charge/discharge and therefore a lithium-ion battery in which performance degradation due to active material volume expansion is minimized can be provided.

A negative electrode for a lithium-ion battery can be produced by, for example, forming a negative-electrode active material layer including a negative-electrode active material including the negative-electrode material described above and a binding agent on a negative-electrode charge collector. A well-known negative-electrode active material other than the negative-electrode materials according to the present invention may be added to the negative-electrode active material as necessary. The negative electrode can be formed using a common slurry coating method. Specifically, a slurry containing a negative-electrode active material, a binding agent and a solvent may be prepared, the slurry may be applied to a negative-electrode charge collector, may be dried and, if necessary, pressed, to provide a negative electrode. Methods for applying negative-electrode slurry include a doctor blade method, a die coater method, and a dip coating method. Alternatively, after a negative-electrode active material layer is formed in advance, a metal thin film may be formed as a charge collector by using a method such as vapor deposition or sputtering, thereby providing a negative electrode.

The negative electrode binding agent may be, but is not limited to, polyvinylidene difluoride (PVdF), vinylidene fluoride-hexafluoropropylene copolymer, vinylidenefluoride-tetrafluoroethylene copolymer, styrene-butadiene copolymer rubber, polytetrafluoroethylene, polypropylene, polyethylene, polyimide, polyamide-imide, methyl(meth)acrylate, ethyl(meth)acrylate, butyl(meth)acrylate, (meth)acrylonitrile, SBR (styrene-butadiene rubber), isoprene rubber, butadiene rubber, or fluoro-rubber. The slurry solvent may be N-methyl-2-pyrolidone (NMP) or water. If water is used as the solvent, carboxymethyl cellulose, methyl cellulose, hydroxymethyl cellulose, ethyl cellulose, or polyvinyl alcohol may be additionally used as a thickening agent.

The content of the binding agent for the negative electrode is preferably in the range of 0.1 to 30% by mass, more preferably in the range of 0.5 to 25% by mass, and yet more preferably in the range of 1 to 20% by mass, in view of a tradeoff between binding strength and energy density.

The negative-electrode charge collector is preferably, but not limited to, copper, nickel, stainless steel, molybdenum, tungsten, tantalum, and an alloy containing two or more of these, in view of electrochemical stability. The negative-electrode charge collector may be in the form of foil, plate, or mesh.

### (Positive Electrode)

A positive electrode can be produced by forming a positive-electrode active material layer on a positive-electrode charge collector, by, for example, preparing a slurry containing a positive-electrode active material, a binding agent and a solvent (and a conduction aid, if necessary), applying the slurry to the positive-electrode charge collector, drying and, if necessary, pressing the resulting electrode. As in the negative electrode, the positive-electrode active material layer may be formed and then a thin film for a charge collector may be formed.

The positive-electrode active material may be, but is not limited to, lithium composite oxide or lithium iron phosphate, for example. Lithium composite oxides include: lithium manganese oxide (LiMn₂O₄, Li₂MnO₃); lithium cobaltite (LiCoO₂); lithium nickel oxide (LiNiO₂); these lithium compounds in which at least part of manganese, cobalt, or nickel is substituted for another metal element such as aluminum, magnesium, titanium, or zinc; nickel-substituted lithium manganese oxide in which at least part of manganese of manganese oxide lithium is substituted for nickel; cobalt-substituted lithium nickel oxide in which at least part of nickel of lithium nickel oxide is substituted for cobalt; nickel-substituted lithium manganese oxide in which part of manganese is substituted for another metal (for example, at least one of aluminum, magnesium, titanium, and zinc); and cobalt-substituted lithium nickel oxide in which part of nickel is substituted for another metal element (for example, at least one of aluminum, magnesium, titanium and zinc). These lithium composite oxides may be used singly or a mixture of two or more of these lithium composite oxides may be used. The positive-electrode active material may be one that has an average particle size in the range of 0.1 μm to 50 μm, preferably in the range of 1 to 30 μm, more preferably in the range of 5 to 25 μm, in view of reactivity with the electrolyte, rate performance and other properties. The term average particle size as used herein means a particle size (median size: D50) where an integrated value is 50% in a particle size distribution (volumetric basis) in a laser diffraction scattering method.

The binding agent for the positive electrode may be, but is not limited to, one similar to the binding agent for the negative electrode. In particular, polyvinylidene difluoride is preferable in view of general versatility and low cost. The content of the positive electrode binding agent is preferably in the range of 1 to 25 parts by mass, more preferably in the range of 2 to 20 parts by mass, yet more preferably in the range of 2 to 10 parts by mass, based on 100 parts by mass of a positive-electrode active material, in view of a tradeoff between binding strength and energy density. Binding agents, other than polyvinylidene difluoride (PVdF), that can be used include vinylidenefluoride-hexafluoropropylene copolymer, vinylidenefluoride-tetrafluoroethylene copolymer, polytetrafluoroethylene, polypropylene, polyethylene, polyimide, and polyamide-imide. N-methyl-2-pyrrolidone (NMP) may be used as the slurry solvent.

The material of the positive-electrode charge collector may be, but is not limited to, for example, aluminum, nickel, titanium, tantalum, stainless steel (SUS), other valve metal or an alloy of any of these metals, in view of electrochemical stability. The positive-electrode charge collector may be in the form of foil, plate, or mesh. Especially, aluminum foil may be preferably used.

When producing the positive electrode, a conduction aid may be added in order to decrease impedance. Examples of the conduction aid may include carbonaceous fine particles such as graphite, carbon black, acetylene black, ketjen black, carbon nanotubes, carbon nanofibers, activated carbon, carbon nanohorn aggregates or the like.

### (Electrolyte)

The electrolyte may be a nonaqueous electrolyte solution made by dissolving lithium salt in one or more nonaqueous solvents. The nonaqueous solvent may be, but is not limited to, cyclic carbonate such as ethylene carbonate (EC), propylene carbonate (PC), butylene carbonate (BC), and vinylene carbonate (VC); chain carbonate such as dimethyl carbonate (DMC), diethyl carbonate (DEC), ethyl methyl carbonate (EMC), and dipropyl carbonate (DPC); aliphatic carboxylic acid such as methyl formate, methyl acetate, and ethyl propionate; y-lactone such as y-butyrolactone; chain ether such as 1,2-ethoxyethane (DEE) and ethoxy methoxyethane (EME); and cyclic ether such as tetrahydrofuran and 2-methyltetrahydrofuran, for example. Other nonaqueous solvents such as an aprotic organic solvent may be used, such as: dimethylsulfoxide, 1,3-dioxolan, dioxolan derivative, formamide, acetamide, dimethylformamide, acetonitrile, propionitrile, nitromethane, ethylmonoglyme, phosphate triester, trimethoxy methane, sulfolane, methylsulfolane, 1,3-dimethyl-2-imidazolidinone, 3-methyl-2-oxazolidinone, propylene carbonate derivative, tetrahydrofuran derivative, ethyl ether, 1,3-propanesultone, anisole, and N-methylpyrrolidone.

Lithium salt to be dissolved in a nonaqueous solvent may be, but is not limited to, LiPF₆, LiAsF₆, LiAlC₄, LiCIO₄, LiBF₄, LiSbF₆, LiCF₃SO₃, LiCF₃CO₂, Li(CF₃SO₂)₂, LiN(CF₃SO₂)₂, and lithium bis(oxalate)borate, for example. These lithium salts may be used singly or in combination. Instead of a nonaqueous electrolyte solution, a polymer electrolyte may be used.

### (Configuration of Battery)

A battery can be configured by placing active material layers of the positive electrode and the negative electrode so as to face each other and filling the gap between the layers with the electrolyte described above. A separator can be provided between the positive electrode and the negative electrode. The separator may be a porous film, woven fabric or nonwoven fabric made of polyolefin such as polypropylene or polyethylene, fluororesin such as polyvinylidene difluoride, or polyimide.

The battery may have a cylindrical, prismatic, coin, button or laminated form. In the case of a laminated form, preferably a laminated film is used as a container for housing the positive electrode, the separator, the negative electrode and the electrolyte. The laminated film includes a resin base material, a metal foil layer, and a heat-seal layer (sealant). The resin base material may be polyester or polyamide (nylon), and the metal foil layer may be aluminum, aluminum alloy or titan foil. The heat-seal layer may be made of a thermoplastic polymer material such as polyethylene, polypropylene, or polyethylene terephthalate. Each of the resin base material layer and the metal foil layer is not limited to one layer but may be made up of two or more such layers. Aluminum laminated film is preferable in view of general versatility and cost.

The positive electrode, the negative electrode and the separator disposed between them are placed in a container made of laminated film or the like and, if a nonaqueous electrolyte is used, the electrolyte is injected into the container, and the container is sealed. A structure in which electrodes that are a plurality of electrode pairs stacked are contained may also be employed.

### EXAMPLES

Examples are given below and the present invention will be illustrated and described in further detail. Of course, the present invention is not limited by the examples given below.

### Example 1

Pitch coke (7 g), SiO (3 g), and carbon nanotubes (200 mg) were soaked in ethanol and ultrasonic dispersion was performed for one minute. The resulting dispersion liquid was filtered and dried at 100° C. for five hours to obtain mixture A. The prepared mixture A was placed in a boat made of alumina, was heated in an argon gas stream (500 ml/min) to 1000° C., was burnt with heat for three hours and then the temperature of mixture A was decreased to 800° C. in the argon stream to stabilize mixture A. Then, ethylene gas was injected into the argon gas stream at 100 ml/min and carbon was deposited for 20 minutes. Then, the ethylene gas injection was stopped and the temperature of mixture A was decreased to near room temperature in argon (composite A). The resulting composite A and carbon nanohorn aggregates were dispersed in an ethanol solution, the dispersion liquid was filtered and was dried at 100° C. for five hours (composite B). A composite (composite C) was also produced using pitch coke (5 g) and SiO (5 g).

Results of a thermogravimetric analysis of composite A, mixture A and silicon oxide (SiO) in an oxygen atmosphere are given in FIG. 2. Because silicon oxide is oxidized (SiOx: x>1) in a high-temperature region, the weight of silicon oxide increased. A region in which composite A and the mixture do not coincide with each other is a combustion region of a carbon coating (deposited carbon), which is between 500° C. and 650° C. Therefore, it can be seen that carbon was not graphitized. Further, a weight difference at 1000° C. represents the amount of the carbon coating, which is approximately 7% by mass. The amount of a carbon coating of composite C was also 7% by mass.

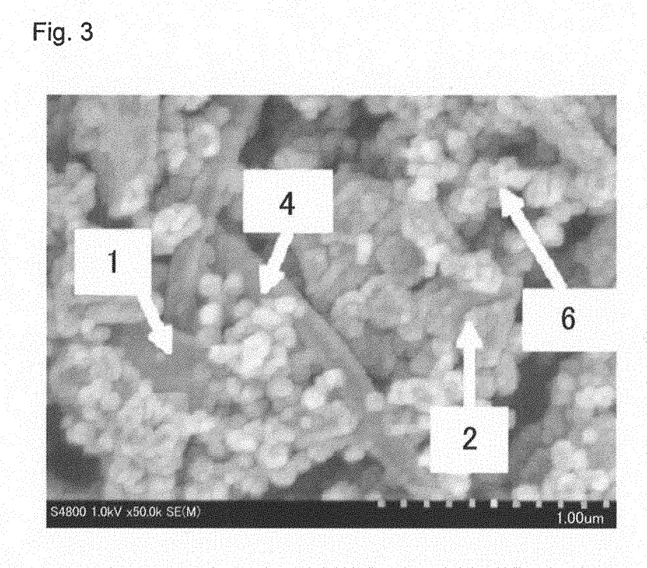

FIG. 3 illustrates an electron scanning microscopy image of composite B. SiO (with a particle size of ˜3 μm) 2, pitch coke (with a particle size of ˜15 μm) 1, and fibrous carbon (carbon nanotubes) 4 were observed. In addition, it was seen that carbon nanohorn aggregates 6 were supported in such a way that gaps were filled with the carbon nanohorn aggregates 6. Further, SiO was sliced into thin sections using a focused ion beam (FIB), the SiO sections were observed with an electron microscope, and Si particles having sizes less than or equal to 10 nm were identified. In addition, the average particle size of Si particles was evaluated using X-ray diffraction and was found to be approximately 7 nm.

### Example 2

90% of Composites A, B and C, pitch coke, and mixture B (a mixture of pitch coke, silicon oxide coated with carbon, carbon nanotubes, and carbon nanohorn aggregates) by mass prepared in example 1 was mixed with a 10% of polyvinylidene difluoride (PVDF) by mass and, in addition, N-methyl-2-pyrrolidone was mixed and was agitated well to prepare negative-electrode slurry. The negative-electrode slurry was applied to a 10-μm-thick copper foil to a thickness of 100 μm. Then the slurry was dried at 120° C. for one hour and was then pressed using a roller press to form an electrode. The electrode was die-cut into a 2-cm² negative electrode. A lithium-ion secondary battery (a test cell) was produced using the obtained negative electrode, Li foil serving as a positive electrode, an electrolyte and a separator. The electrolyte was prepared by dissolving LiPF₆ in a mixed solvent of ethylene carbonate and methyl ethyl carbonate (at a volume ratio of 3:7) with a concentration of 1 M. As the separator, a 30-μm-thick porous film of polyethylene was used.

Charge/discharge performance of the produced secondary battery was investigated as follows. First, the secondary battery was set in a charge/discharge tester, the battery was charged with a constant current of 0.1 mA/cm² to a voltage of 0.02 V, then the current was decreased at a voltage of 0.02 V to charge the battery. When the current value reached 50 μA/cm², the charge was stopped. The battery was discharged at a constant current of 0.1 mA/cm² and, when the cell voltage reached 1.5 V, the discharge was ended and the discharge capacity was determined. In addition, charge and discharge measurements were performed at 0.1 C, 0.2 C, 2C, 5C and 10C to evaluate rate performance (C-rate: 1 C means that the battery is discharged to a predetermined voltage in one hour). 100 charge/discharge cycles were performed in the range of 0.02 V to 1.0 V and the capacity retention was also evaluated. The results are given in Table 1.

TABLE 1

| | DISCHARGE | CAPACITY | | | | | |
|---|---|---|---|---|---|---|---|
| | CAPACITY | RETENTION | | 0.2 C/0.1 C | 2 C/0.1 C | 5 C/0.1 C | 10 C/0.1 C |
| | (mAh/g) | (%) | | (%) | (%) | (%) | (%) |
| PITCH | 200 | 95 | DISCHARGE | 97 | 75 | 31 | 8 |
| COKE | | | CHARGE | 95 | 34 | 10 | 2 |
| MIXTURE | 590 | 85 | DISCHARGE | 97 | 84 | 68 | 30 |
| B | | | CHARGE | 92 | 25 | 2 | — |
| COMPOS- | 595 | 85 | DISCHARGE | 84 | 33 | 20 | 4 |
| ITE A | | | CHARGE | 79 | 14 | — | — |
| COMPOS- | 600 | 90 | DISCHARGE | 98 | 88 | 76 | 55 |
| ITE B | | | CHARGE | 92 | 35 | 10 | 2 |
| COMPOS- | 850 | 88 | DISCHARGE | 87 | 30 | 10 | — |
| ITE C | | | CHARGE | 88 | 15 | — | — |

As can be seen from Table 1, performance of composite B is excellent at all rates of charge/discharge. Further, composite B exhibits the highest capacity retention value among the materials excluding pitch coke. From the foregoing, it can be seen that the secondary battery according to the present example embodiment has improved discharge performance and improved capacity retention. This is effects of a lowered resistance of the composite formed by coating mixture A with the carbon coating, the good functionality of the carbon nanohorn aggregates as a conducting material, and mitigation of volume expansion due to charge/discharge. Composite C exhibits a high discharge capacity because composite C contains an increased amount of silicon oxide. However, the rate performance of composite C is lower than the rate performance of composite B. This means that it is preferable that the amount of silicon oxide is less than 50% by mass.

While the present invention has been described with reference to example embodiments and examples thereof, the present invention is not limited to the example embodiments and examples described above. Various modifications which are apparent to those skilled in the art can be made to the configurations and details of the present invention within the scope of the present invention.

This application is based upon and claims the benefit of priority from Japanese Patent Application No. 2014-117431, filed on Jun. 6, 2014, the entire disclosure of which is incorporated herein.

### REFERENCE SIGNS LIST

1 Low-crystallinity carbon
2 Silicon oxide
3 Silicon nanoparticle
4 Fibrous carbon
5 Carbon coating
6 Carbon nanohorn aggregate
7 Nano-carbon composite

1. A nano-carbon composite comprising: low-crystallinity carbon; a composite in which a mixture of silicon oxide containing silicon nanoparticles and fibrous carbon are partially or entirely coated with a carbon coating; and carbon nanohorn aggregates supported on a surface of the composite.

2. The nano-carbon composite according to claim 1, wherein the low-crystallinity carbon is selected from graphitizable carbons.

3. The nano-carbon composite according to claim 1, wherein the composite contains 50% or less of the silicon oxide by mass, 0.1 to 10% of the fibrous carbon by mass, 0.1 to 10% of the carbon coating by mass, and the remainder being the low-crystallinity carbon, and the carbon nanohorn aggregates are 1 to 30% by mass to the composite.

4. The nano-carbon composite according to claims 1, wherein the low-crystallinity carbon is particles having an average particle size in the range between 100 nm and 100 μm inclusive, silicon nanoparticles contained in the silicon oxide have a diameter less than or equal to 20 nm, and the silicon oxide is particles having an average particle size in the range between 100 nm and 50 μm inclusive.

5. The nano-carbon composite according to claim 1, wherein the carbon nanohorn aggregates are of one type selected from the group consisting of petal type, dahlia type, bud type, and seed type or a mixture of two or more types selected from the group.

6. The nano-carbon composite according to claim 1, wherein the fibrous carbon is of at least one type selected from the group consisting of carbon nanofiber and carbon nanotube.

7. An electrode material for a lithium-ion secondary battery, the electrode material comprising the nano-carbon composite according to claim 1 and at least one conduction aid selected from the group consisting of carbon black, acetylene black, ketjen black, furnace black, activated carbon, carbon nanotube, carbon nanofiber, and graphene.

8. A lithium-ion secondary battery comprising the nano-carbon composite according to claim 1.

9. A method for producing a nano-carbon composite, comprising the steps of:
forming a mixture of low-crystallinity carbon or a precursor of low-crystal carbon, silicon oxide (SiOx (0<x<2)), and fibrous carbon;
changing the silicon oxide to silicon oxide containing silicon nanoparticles by heating the mixture at a temperature in the range between 500° C. and 1800° C. inclusive in a non-oxidizing atmosphere;
forming a composite by partially or entirely coating a surface of the mixture with a carbon coating; and
supporting carbon nanohorn aggregates on a surface of the composite.

10. The method for producing a nano-carbon composite according to claim 9, wherein the carbon coating is formed by depositing an organic substance on a surface of the mixture and carbonizing using heat burning of the organic substance at a temperature of 500° C. to 1800° C. or by using a carbon source to perform chemical vapor deposition at a temperature of 400° C. to 1200° C.

11. A lithium-ion secondary battery comprising the nano-carbon composite according to claim 7.
